(19) United States
(12) Patent Application Publication
(10) Pub. No.: US 2008/0126610 A1
(43) Pub. Date: May 29, 2008

(54) Embedded system and communication method thereof

(75) Inventors: Bo He, Shenzhen (CN); Xiaoyu Wu, Shenzhen (CN); Jian Cen, Shenzhen (CN)

Correspondence Address: MINDRAY C/O STOEL RIVES LLP, 201 S. MAIN STREET, SUITE 1100, SALT LAKE CITY, UT, 84111, US

(73) Assignee: SHENZHEN MINDRAY BIO-MEDICAL ELECTRONICS CO., LTD., Shenzhen (CN)

(21) Appl. No.: 11/636,223

(22) Filed: Dec. 8, 2006

(30) Foreign Application Priority Data
Sep. 5, 2006 (CN) 200610021807.9

(51) Int. Cl. G06F 13/14

(52) U.S. Cl. 710/30

(57) ABSTRACT

A system comprises an embedded processor A, a processor or equipment B and a FPGA/CPLD module, wherein a synchronous serial port of the embedded processor A is connected with the FPGA/CPLD module; in which a transmission clock and transmission frame synchronization signal are taken as output, while a receiving clock and receiving frame synchronization signal are taken as input; and a communication interface of the processor or equipment B is connected with the FPGA/CPLD module. This system ensures that the data transmitting party always take initiatives during communications with processor of equipment B. Via the FPGA/CPLD module, the system may interface with other systems through different communication protocols, such that the system need not modify its solutions to adapt to different protocols, but only upgrades the logic of the FPGA/CPLD to adapt to the new interfaces. As such, a high-speed, reliable and flexible communication mechanism is established.

### RELATED APPLICATION

The present application claims the priority of the Chinese Patent Application No. 200610021807.9, titled “Embedded System and Communication Method Thereof”, which is filed on Sep. 5, 2006, and is incorporated herein by reference.

### FIELD OF THE INVENTION

The present invention relates to a data communication method, in particular, to a data communication method used for an embedded system.

### BACKGROUND OF THE INVENTION

In prior art, the communications for an embedded system are generally classified as follows:

1. Universal Asynchronous Receiver/Transmitter (UART)

UART is the abbreviation for Universal Asynchronous Receiver/Transmitter, in compliance with the industrial asynchronous communication standard. At present, most embedded processors are provided with UART interface. The asynchronous communications allows for inter-processor communications in the absence of a common reference clock. The two parties concerned in the communications use the same baud rate, and the unit for data transmitting and receiving is frame. A frame is a bit series conveyed through a communication link.

One frame consists of one start bit, a plurality of data bits (normally 5-8 bits), and one or two stop bits, and may includes an odd-even check bit. FIG. 1 shows a typical frame format used for asynchronous communications. Data receiving and transmitting are independent with each other, and may be performed simultaneously, which belongs to full duplex communications.

UART has the disadvantages that the baud rate should be agreed upon by the two parties in communications, otherwise communications cannot be carried out; communications would come to a failure in case the baud rate is changed unilaterally; the clock sources of the two parties should match, otherwise there exists difference in the baud rate recognized bilaterally; and the error is allowed but should not be too large. How well the clock sources of the two parties match determines the upper limit of the communication speed. In most cases, the asynchronous mode can hardly achieve a relatively high speed.

2. Serial Peripheral Interface (SPI)

SPI is the abbreviation for Serial Peripheral Interface. SPI uses three lines to accomplish high-speed communications between two chips, among which two data lines are used for receiving and transmitting data, and one clock line for synchronization. The communications of SPI belong to the mode of Master-Slave, in which the CPU is normally used as the master equipment to control the data transfer process. The CPU controls the data transmitting and receiving via the equipment by way of programming the equipment.

The CPU may be connected with various equipment through SPI, such as shift registers, A/D and D/A converters, LCD controllers and other processors.

Each equipment supporting SPI has one chip select line, such that a synchronous communication network may be set up via SPI, in particular suitable for one-master multiple-slave network, in which the slave is an equipment rather than CPU. Multiple-master multiple-slave may also be realized, however, the control thereof is rather complicated.

SPI has the following disadvantages: for an embedded system that has a plurality of CPUs, if the CPUs communicate through SPI, then data receiving and transmitting cannot be completely independent; data transmitting from CPU is passive, and a great difficult is posed to the coordination between data receiving and transmitting and the control power.

3. Synchronous Serial Port (SPORT)

Partially embedded processors provide the communication interface SPORT (Synchronous Serial Port). SPORT refers to synchronous serial port. Via programming, a group of communication protocols having a variety of formats are supported. Each SPORT includes 8 (or 6) PINs, 4 (or 3) out of which are for receiving, and 4 (or 3) for transmitting. Receiving and transmitting are completely independent, as well as formats setting are also completely independent. Those 4 transmitting PINs comprise clock, frame synchronization, primary data, and secondary data (not present in the case of 3 transmitting PINs). Wherein the clock provides the basis for synchronous communications; the frame synchronization signal indicates the start of one frame; either the primary data or the secondary data may be used, or both of them. One equipment may be communicated with when using one of them, while two equipments may be communicated with when using both of them. FIG. 2 illustrates a typical case in which the processor is connected with other equipments through SPORT, in which TSCLK, TFS, DT PRI belonging to portions of the transmitter are respectively the transmission clock, frame synchronization and primary data (the secondary data unused); while RSCLK, RFS, DR PRI belonging to the receiver are respectively the receiving clock, frame synchronization and primary data (the secondary data unused).

FIG. 3 is a typical sequence chart, in which RFS OUTPUT and RFS INPUT refer to two cases in which the frame synchronization signal is used as an input or output, and one of them is selected in practical application.

FIG. 4 is a schematic view of the internal structure. The transmitting portion and the receiving portion are completely independent, and each of the clock signal, frame synchronization signal may be taken as an input or output.

SPORT enables flexible communications through programming, the setup of which is generally characterized as:

1. the word length is 3-32 bits;

2. the clock signal and the frame synchronization signal frequency (when taken as output) are defined;

3. the bit sequence may be either MSB priority or LSB priority;

4. the clock (frame synchronization) signal is generated by internal equipment when defined as output, or by external equipment when defined as input;

5. the frame synchronization signal may be defined as necessary or unnecessary;

6. the frame synchronization signal may be variously configured when defined as necessary;

7. the data sampling may make use of the trailing edge or the rising edge of the clock;

8. a multichannel time division multiplexing communication mode may be configured.

### SUMMARY OF THE INVENTION

It is an object of the present invention to provide a high-speed, reliable and flexible embedded system and a communication method thereof, which overcome the deficiency in prior art.

In accordance with the first aspect of the present invention, there is provided an embedded system, comprising an embedded processor A, a processor or equipment B and a FPGA/CPLD module, wherein an synchronous serial port of the embedded processor A is connected with the FPGA/CPLD module; in which an transmission clock and transmission frame synchronization signal are taken as output, while a receiving clock and receiving frame synchronization signal are taken as input; and a communication interface of the processor or equipment B is connected with the FPGA/CPLD module.

The embedded system according to the present invention comprises at least one processor or equipment B which has same or different communication protocol.

In accordance with the second aspect of the present invention, there is provided a communication method for an embedded system, comprising data transmitting from a processor A to a processor or equipment B. Particularly, processor A transmits data to a FPGA/CPLD module according to a communications protocol A′ thereof, and then the FPGA/CPLD module performs format conversion on the data from the processor A according to a communication protocol B′ of the processor or equipment B and finally forwards the converted data to the processor or equipment B.

The communication method in accordance with the second aspect of the present invention further comprises data transmitting from the processor or equipment B to the processor A. Particularly, the processor or equipment B transmits data to the FPGA/CPLD module according to the communication protocol B′ thereof, and then the FPGA/CPLD module performs format conversion on the data according to the communication protocol A′ of processor A and finally forwards the converted data to the processor A.

In this respect, where there are two or more processors or equipments B, the processor A adds a channel flag bit to the transmitted data so as to indicate communication channel. The FPGA/CPLD module then forwards the data to the corresponding processor or equipment B according to the channel flag bit.

In addition, where there are two or more processors or equipments B, while performing format conversion upon the data received from the processor or equipment B, the FPGA/CPLD adds a channel flag bit to each frame of the data to indicate the communication channel. Therefore, the processor A identifies the corresponding processor or equipment B which transmits the data according to the channel flag bit of the received data.

In accordance with the third aspect of the present invention, there is provided another communication method for an embedded system, comprising data transmitting from a processor A to a processor or equipment B. Particularly, a FPGA/CPLD module receives data transmitted from the processor A upon recognition that the frame synchronization signal is transmitted from the processor A, then identifies a data packet according to a protocol A′ agreed upon with the processor A, and finally forwards the data to the processor or equipment B according to a protocol B′ agreed upon with the processor or equipment B.

The communication method in accordance with the third aspect of the present invention further comprises data transmitting from the processor or equipment B to the processor A. Particularly, the FPGA/CPLD module receives data transmitted from the processor or equipment B, then identifies the data packet according to the protocol B′ agreed upon with the processor or equipment B, and finally forwards the data to the processor A according to the protocol A′ agreed upon with the processor A.

Optionally, when the processor A is transmitting data, a channel flag bit indicating the targeted processor or equipment B is written into the data; and when forwarding the data, the FPGA/CPLD module forwards the data to the corresponding processor or equipment B according to the identified channel flag bit of the data.

Further Optionally, when forwarding the data, the FPGA/CPLD module identifies the channel of processor or equipment B and adds the corresponding channel flag bit to the data, which is then forwarded to the processor A; and the processor A identifies data transmitting party according to the channel flag bit.

With the above solutions, the following advantageous effects are brought about:

Via the FPGA/CPLD module, the system may interface with other systems by using different communication protocols, such that the system solution is not needed to be adapted merely because of the difference in protocols, and what is now required is simply updating the logic of FPGA/CPLD to suit for the new interface. As to FPGA/CPLD with rich resources, various protocols may be realized. In case the application environment varies, only one handshake or modification of configuration information is needed to achieve communications with different systems.

The programmable synchronous serial ports are combined with the programmable logic devices. With the variability of word length and flexibility of the programmable logic devices, the communication adaptability is enhanced through arrangement of an additional bit for each fame of data so as to create a high-speed, reliable and flexible communication mechanism. The communication control is simple and reliable.

Due to synchronous communications, the clock may be controlled by either party, usually by data transmitting party, and the clock source matching between the two parties is not required. The speed may be determined as desired, and the clock frequency may be increased unilaterally (the transmitting party). The speed may meet the requirements in most cases, as a result of which FPGA/CPLD can be put to greater uses than the currently most widely used UART.

The frame synchronization signal distinguishes individual frames by hardware. Generally, the two parties in communication are initialized at different time. However, with the frame synchronization signal, it is possible for the two parties to start at different time and immediately enter into the correct communication status. Even if an accidental abnormality occurs, the frame resolution may come back to the right track quickly, which is therefore more reliable.

With the self-description of the data realized by the additional bit arranged in the word length, the reliability of data packet resolution is improved.

FPGA/CPLD enables a plurality of communication interfaces to suit for various applications. Hence, the system architecture is not required to be redesigned only due to a single problem of the communication interface, thus the flexibility is greatly improved.

In more and more systems, FPGA/CPLD itself constitutes a portion of the system, and no extra costs are incurred even if the mode of SPORT+FPGA/CPLD is superimposed.

### BRIEF DESCRIPTION OF THE DRAWINGS

FIG. 1 illustrates a typical asynchronous communication frame format;

FIG. 2 illustrates a typical connection of SPORT;

FIG. 3 is a typical sequence chart of SPORT;

FIG. 4 is a typical structural diagram of SPORT;

FIG. 5 shows the SPORT plus FPGA/CPLD communication mode according to one embodiment;

FIG. 6 is the data transmitting flow chart according to the one embodiment;

FIG. 7 shows the one-to-multiple communication mode according to another embodiment;

FIG. 8 illustrates the definition of the intraframe bit of the one-to-multiple communication mode according to the another embodiment;

FIG. 9 is the data transmitting flow chart of the one-to-multiple communication mode according to the another embodiment;

FIG. 10 is the data receiving flow chart of one-to-multiple communication mode according to the another embodiment.

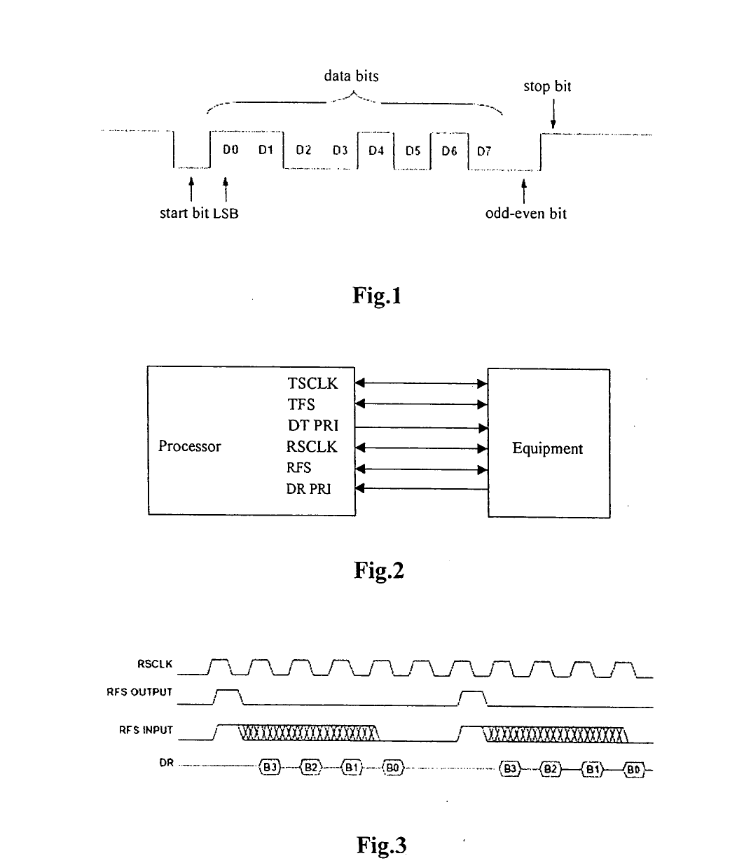

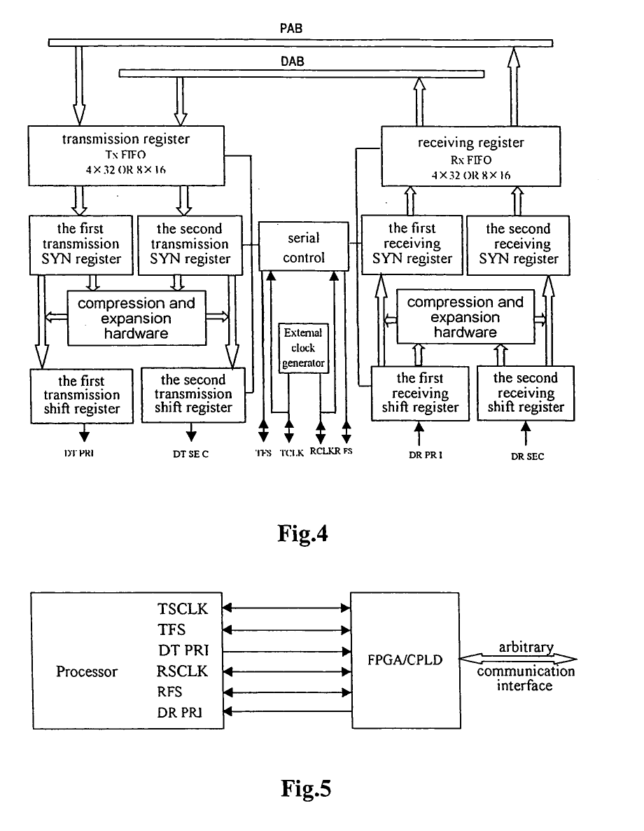

### DETAILED DESCRIPTION OF THE INVENTION

By way of examples, the present invention will be described in further details hereunder with reference to the accompanying drawings.

### Example 1

With reference to FIG. 5, the embedded system comprises an embedded processor A, a processor or equipment B (not shown), and a FPGA/CPLD module. The SPORT of the embedded processor is connected with the FPGA/CPLD. According to system requirements, the FPGA/CPLD may convert the SPORT into any communication interface, so as to meet the demand of high flexibility of communications.

Under this connection, the main settings are as follows:

1. TSCLK, TFS are taken as the output, and the transmitting is entirely controlled by the processor; RSCLK, RFS are taken as the input, and are entirely controlled by the FPGA/CPLD. In case of the FPGA/CPLD, the receiving of the processor is equivalent to the transmitting. Therefore, it is so configured herein that the transmitting party takes the initiative. Both the parties serve as a transmitting party as well as a receiving party;

2. the frame synchronization signal is required;

3. the word length is characterized as the equation: word length=number of the effective bits+number of the additional bits;

4. The data most significant byte (MSB) or data least significant byte (LSB) needs to be agreed upon by the two parties.

In communications, usually an application-level protocol should be provided so as to transfer data with different meanings, which should be packaged according to the different meanings. Each packet comprises a plurality of frames which may vary in number due to different packets. Therefore, each of the packets should be identified. A method commonly adopted for the identification is that each of the packets starts with a particular frame. The starting of a packet is identified using software. A flexible configuration of the word length may realize the identification of the starting of the data packet on hardware, and the software may identify the packet with a brief judgment.

The word length is characterized by the equation: word length=number of the effective bits+number of the additional bits. The number of the effective bits refers to the information to be originally transferred, for example, one byte with 8 bits. The additional bit is intended to indicate the meaning of each word (frame). For example, with the addition of one additional bit, 1 means the starting of a data packet, with 0 means otherwise. As such, the starting of the data packet may be identified reliably and easily. Of course, the number of effective bits is not limited to 8, and that of the additional bits is not limited to 1. One bit can only represent two data properties, and two bits may represent four. The reliability of the resolution of data packet is improved with the possibility in the description of the data itself through the additional bit.

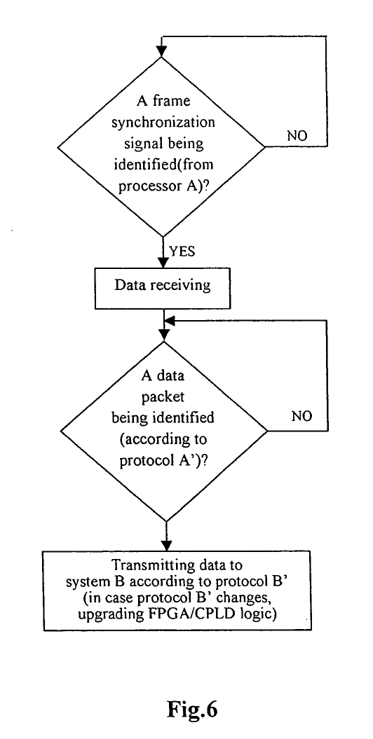

It is assumed that the protocol between processor A and FPGA/CPLD is protocol A′, and the protocol between FPGA/CPLD and other processors or equipment B is protocol B′, in which protocol A′ is a fixed protocol that needs no modification after design, while protocol B′ is a variable protocol that may vary according to the different systems to be connected with. According to different systems, the FPGA/CPLD module may be logically upgraded. The flow chart of data transmitting from the processor A to the processor or equipment B is shown in FIG. 6. One frame synchronization signal as received from the processor A signifies the receiving of data in the amount of one word, which data, upon receiving, is identified with protocol A′, then converted into a new format according to protocol B′, and finally is transmitted to the processor or equipment B.

### Example 2

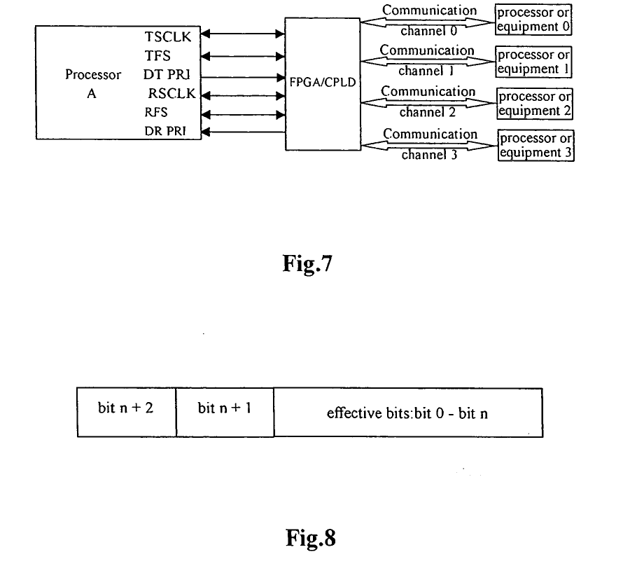

FIG. 7 shows a solution of realizing a one-to-multiple communication mode. There are four processors or equipments B communicating with a processor A. In other words, the number of the communication interfaces of processors or equipments 0˜3 is not limited strictly, or there could be arbitrary number of communication interfaces so long as FPGA/CPLD possesses sufficient I/O interfaces.

Through the definition of the additional bit, a plurality of communication channels is created. The one-to-four mode is herein taken as an example for illustration. Each frame data is defined as what is shown in FIG. 8. The effective bits 0˜n is the data originally intended to be transferred, while the (n+1)th and the (n+2)th bits are the additional bits for describing the channel information. When the processor A is transmitting data to processor 0, the additional bit is defined as 00; when transmitting data to processor 1, the additional bit as 01, and so on. Where two additional bits are defined, four channels may be created. When processors 0˜3 are transmitting data to the processor A, the data is firstly transmitted to FPGA/CPLD which adds the additional bit to the data before forwards the data to the processor A. Thereby the processor A may identify the source of the data. If one more bit is added to the above additional bits, 8 channels are capable of being established.

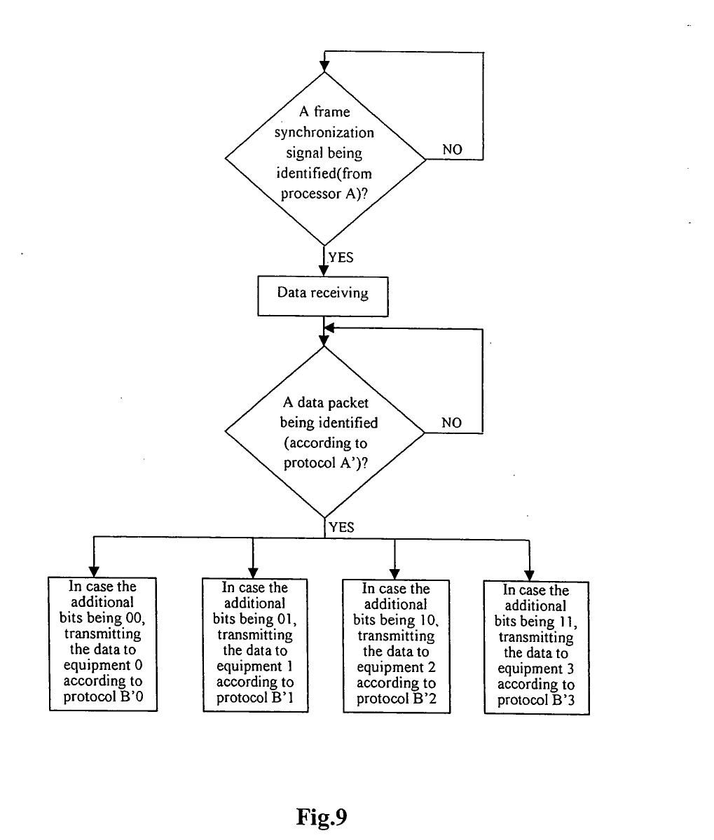

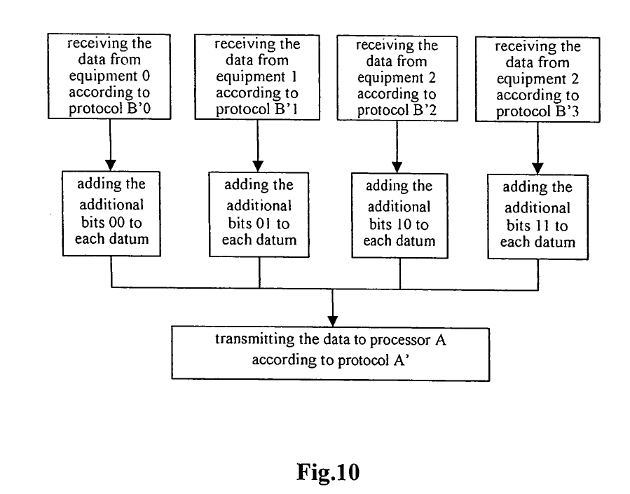

The four equipments are equipment 0, equipment 1, equipment 2, and equipment 3, respectively, and respective protocols thereof are B′0, B′1, B′2 and B′3. When the processor A is transmitting data, the additional bits 00 means transmitting data to equipment 0; 01 means transmitting data to equipment 1; 10 means transmitting data to equipment 2; and 11 means transmitting data to equipment 3. If the data is transmitted to the processor A from a certain equipment, FPGA/CPLD adds the additional bits to the data according to the equipment number and then transmits the data to processor A. The flow chart of data receiving and transmitting from the processor to multiple equipments is shown in FIG. 9 and FIG. 10.

FIG. 9 shows the flow chart of data transmitting from the processor A to processor or equipment Bn. One frame synchronization signal as received from the processor A signifies the receiving of data in the amount of one word, which data, upon receiving, is then identified with the protocol A′. Upon identification of Bn, the data receiving party, through the additional bits, the data is subsequently converted into a new format according to protocol B′n, and finally transmitted to processor or equipment Bn. FIG. 10 shows the flow chart of data transmitting from processor or equipment Bn to the processor A. The data from processor or equipment Bn is received in accordance with protocol B′n, and having been determined in respect of the value of the additional bits (as the channel information) according to n, then transmitted to the processor A according to the protocol A′.

The present invention may be applied to embedded systems that require a communication function, which covers a rather wide range, for example, measurement system, home appliances, communication equipment, control system and the like. In the information monitor taking advantage of the present invention, it is proved experimentally that communications between the parameter measurement module and the main control module are normal and produces the above claimed advantageous effect.

The present invention is described hereinabove by particular examples. The terms or symbols as used herein such as A, B, A′, B′ and the like are only illustrative and shall by no means be intended to limit the present invention. Various modifications, changes, variations, and other equivalent substitutions, without departing from the spirits and scopes of the present invention, are intended to be covered by the appended claims.

1. An embedded system, comprising:
an embedded processor A;
a processor or equipment B; and
a FPGA/CPLD module;
wherein a synchronous serial port of the embedded processor A is connected with the FPGA/CPLD module; in which a transmission clock and transmission frame synchronization signal are taken as output, while a receiving clock and receiving frame synchronization signal are taken as input; and the communication interface of the processor or equipment B is connected with the FPGA/CPLD module.

2. The embedded system of claim 1, wherein it comprises one or more processors or equipments B.

3. The embedded system of claim 2, wherein each processor or equipment B has same or different communication protocol.

4. A communication method for an embedded system, comprising data transmitting from a processor A to a processor or equipment B, which transmitting particularly comprises the following steps:
the processor A transmits data to a FPGA/CPLD module according to a communication protocol A′ thereof;
the FPGA/CPLD module performs format conversion on the data from the processor A according to a communication protocol B′ of the processor or equipment B; and
the FPGA/CPLD module then forwards the converted data to the processor or equipment B.

5. The communication method of claim 4, further comprising data transmitting from the processor or equipment B to the processor A, which transmitting particularly comprises the following steps:
the processor or equipment B transmits data to the FPGA/CPLD module according to the communication protocol B′ thereof;
the FPGA/CPLD module performs format conversion on the data according to the communication protocol A′ of the processor A; and
the FPGA/CPLD module then forwards the converted data to the processor A.

6. The communication method of claim 4, further comprising the following step:
where there are two or more processors or equipments B, the processor A adds a channel flag bit to the transmitted data so as to indicate communication channel.

7. The communication method of claim 5, further comprising the following step:
where there are two or more processors or equipments B, while performing format conversion upon data received from the processor or equipment B, the FPGA/CPLD adds a channel flag bit to each frame of data to indicate communication channel.

8. The communication method of claim 5, further comprising the following step:
where there are two or more processors or equipments B, the processor A adds a channel flag bit to the transmitted data so as to indicate the communication channel.

9. The communication method of claim 7, further comprising the following step:
the processor A identifies the corresponding processor or equipment B transmitting the data according to the channel flag bit added to the received data.

10. The communication method of claim 8, further comprising the following step:
the FPGA/CPLD module forwards data to the corresponding processor or equipment B according to the channel flag bit.

11. A communication method for an embedded system, comprising data transmitting from a processor A to a processor or equipment B, which transmitting particularly comprises the following steps:
a FPGA/CPLD module receives data transmitted from the processor A upon recognition that a frame synchronization signal is transmitted from the processor A; and
the FPGA/CPLD module identifies a data packet according to a protocol A′ agreed upon with the processor A, and forwards the data to the processor or equipment B according to a protocol B′ agreed upon with the processor or equipment B.

12. The communication method of claim 11, further comprising data transmitting from the processor or equipment B to the processor A, which particularly comprises the following steps:
the FPGA/CPLD module receives data transmitted from the processor or equipment B; and
the FPGA/CPLD module identifies the data packet according to the protocol B′ agreed upon with the processor or equipment B, and transmits the data to the processor A according to the protocol A′ agreed upon with the processor A.

13. The communication method of claim 11, further comprising the following steps:
when the processor A is transmitting data, a channel flag bit indicating a targeted processor or equipment B is written into the data; and
when forwarding the data, the FPGA/CPLD module forwards the data to the corresponding processor or equipment B according to identification of the channel flag bit added to the data.

14. The communication method of claim 12, further comprising the following steps:
when forwarding the data, the FPGA/CPLD identifies the channel flag bit of the processor or equipment B and correspondingly adds the same to the data, which is then forwarded to the processor A; and
the processor A then identifies the data transmitting party according to the channel flag bit.
